(19) United States
(12) Patent Application Publication
(10) Pub. No.: US 2016/0109329 A1
(43) Pub. Date: Apr. 21, 2016

(54) METHOD, COMPUTER PROGRAM PRODUCT & SYSTEM

(71) Applicant: AKTIEBOLAGET SKF, Göteborg (SE)

(72) Inventor: Allan THOMSON, Lanark (GB)

(73) Assignee: Aktiebolaget SKF, Göteborg (SE)

(21) Appl. No.: 14/782,366

(22) PCT Filed: Apr. 5, 2013
(86) PCT No.: PCT/EP2013/057177

§ 371 Date: Oct. 5, 2015

(51) Int. Cl. G01M 13/04; G01N 29/14

(52) U.S. Cl. CPC G01M 13/045; G01N 29/14; G01N 2291/0258; G01N 2291/2696

(57) ABSTRACT

A method for processing data obtained from a condition monitoring system, the method comprising steps of: (a) obtaining dynamic Acoustic Emission signal data in the form of a time waveform from at least one sensor, (b) extracting one of a maximum value, a minimum value, or mean value of the time waveform (c) counts of crossing predetermined threshold values, and (d) one of transmitting, displaying, or storing the extracted values and the number of counts instead of the dynamic signal time waveform data.

### CROSS REFERENCE TO RELATED APPLICATION

This is a United States National Stage Application claiming the benefit of International Application Number PCT/EP2013/057177 filed on 5 Apr. 2013 (05.04.2013), which is incorporated herein by reference in its entirety.

### TECHNICAL FIELD

The present invention concerns a method, system and computer program product for processing data obtained from a condition monitoring system, such a condition monitoring system for predicting the residual life of a component, such as a bearing, i.e. for predicting when it is necessary or desirable to service, replace or refurbish (re-manufacture) the component.

### BACKGROUND OF THE INVENTION

Condition monitoring is the process of determining the condition of machinery while in operation. Condition monitoring enables the repair of problem components prior to failure and not only helps plant personnel reduce the possibility of catastrophic failure, but also allows them to order parts in advance, schedule manpower, and plan other repairs during downtime.

Components such as rolling-element bearings are often used in critical applications, wherein their failure in service would result in significant commercial loss to the end-user. It is therefore important to be able to predict the residual life of such a bearing, in order to plan intervention in a way that avoids failure in service, while minimizing the losses that may arise from taking the machinery in question out of service to replace the bearing.

The residual life of a rolling-element bearing is generally determined by fatigue of the operating surfaces as a result of repeated stresses in operational use. Fatigue failure of a rolling element bearing results from progressive flaking or pitting of the surfaces of the rolling elements and of the surfaces of the corresponding bearing races. The flaking and pitting may cause seizure of one or more of the rolling elements, which in turn may generate excessive heat, pressure and friction.

Bearings are selected for a specific application on the basis of a calculated or predicted residual life expectancy compatible with the expected type of service in the application in which they will be used. However, this type of life prediction is considered inadequate for the purpose of maintenance planning for several reasons.

One reason is that the actual operation conditions may be quite different from the nominal conditions. Another reason is that a bearing's residual life may be radically compromised by short-duration events or unplanned events, such as overloads, lubrication failures, installation errors, etc. Yet another reason is that, even if nominal operating conditions are accurately reproduced in service, the inherently random character of the fatigue process may give rise to large statistical variations in the actual residual life of substantially identical bearings.

In order to improve maintenance planning, it is common practice to monitor the values of physical quantities related to vibrations and temperature to which a component, such as a bearing, is subjected in operational use, so as to be able to detect the first signs of impending failure.

In a condition monitoring system data dynamic signal data is obtained in the form of a time waveform (i.e. a graph of a varying quantity against time which usually consists of many samples) from at least one sensor. These time waveforms are usually transmitted and displayed to an analyst. This can however result in long transmission and display times and the data can be difficult to display or interpret. The transmission, display, storage and interpretation of such data can require a significant amount of energy, time and expertise, and consequently decreases the rate at which measurements and analyses can be made.

There are condition monitoring systems using vibration level sensors in which only the “overall amplitudes” (i.e. the total amount of vibration occurring in a selected frequency range) of a particular signal are transmitted or displayed. However, such transmitted or displayed data has limited value since it provides no information about the nature of a signal. Additionally, no further information can be post-processed from the transmitted or displayed overall amplitude values.

### SUMMARY OF THE INVENTION

An object of the invention is to provide an improved method for processing data obtained from a condition monitoring system.

This object is achieved by a method comprising the steps of obtaining dynamic (demodulated) Acoustic Emission (AE) signal data in the form of a time waveform from at least one sensor, extracting a maximum or minimum or mean value of the time waveform and counts of crossing predetermined threshold values, and transmitting or displaying or storing the extracted values and the number of counts instead of the dynamic signal time waveform data.

Such a statistical demodulation method avoids the need to transmit and/or display and/or store the whole time waveform since only certain values extracted therefrom are transmitted and/or displayed and/or stored. The method thereby reduces the amount of data that needs to be transmitted, displayed and/or stored. Transmission, display and data processing times will therefore be shorter, less energy will be required for transmission, display and processing, and memory storage requirements will be substantially lower, which consequently results in extending the sensor battery life, or reducing the sensor battery size or power generation requirement.

A user will consequently be more quickly warned of deterioration in the condition of a component being monitored and poor installation or poor operating practices, such as misalignment, imbalance, high vibration, lack of lubrication and contamination in the lubricant, etc., which would reduce the residual life of the component if left uncorrected, will be more quickly identified

According to an embodiment of the invention the step of extracting values from the time waveform is carried out using Discrete Wavelet Transform (DWT), Continuous Wavelet Transform (CWT) or another time domain analysis.

According to an embodiment of the invention the counts of crossing predetermined threshold values are any of the following: periodic events or amplitudes.

According to an embodiment of the invention the at least one sensor is arranged to obtain data concerning at least one of the following: vibration, vibration enveloping, acoustic emission (AE), acoustic emission enveloping (AEE), load, temperature, rolling contact force/stress, high frequency stress waves, lubricant condition, rolling surface damage, operating speed, load carried, lubrication conditions, humidity, exposure to moisture or ionic fluids, exposure to mechanical shocks, corrosion, fatigue damage, wear.

According to another embodiment of the invention the extracted values and the number of counts are transmitted wirelessly over a wireless communication network.

According to a further embodiment of the invention the method is carried out once the whole of the time waveform has been acquired (which requires more memory). Alternatively, the method is carried out continuously as the time waveform is acquired, for example as sections of the time waveform are acquired in an FIFO buffer (which requires less memory but a faster processor).

According to an embodiment of the invention the method comprises the step of storing the extracted values and the number of counts electronically in a database.

According to another embodiment of the invention the condition monitoring system is arranged to monitor at least one bearing, such as a rolling element bearing. The rolling bearing may be any one of a cylindrical roller bearing, a spherical roller bearing, a toroidal roller bearing, a taper roller bearing, a conical roller bearing or a needle roller bearing.

The present invention also concerns a computer program product that comprises a computer program containing computer program code means arranged to cause a computer or a processor to execute the steps of a method according to any of the embodiments of the invention, stored on a computer-readable medium or a carrier wave.

The present invention further concerns a system for processing data obtained from a condition monitoring system comprising at least one sensor arranged to provide dynamic (demodulated) Acoustic Emission (AE) signal data in the form of a time waveform from the at least one sensor. The system comprises a processing unit arranged to extract a maximum or minimum or mean value of the time waveform and counts of crossing predetermined threshold values, and transmission means arranged to transmit or display or store the extracted values and the number of counts instead of the dynamic signal time waveform data.

According to an embodiment of the invention the counts of crossing predetermined threshold values are any of the following: periodic events or amplitudes.

According to another embodiment of the invention the system comprises transmitting means arranged to transmit the extracted values and the number of counts wirelessly over a wireless communication network.

According to a further embodiment of the invention the processing unit is arranged to extract the values once the whole of the time waveform has been acquired. Alternatively, the processing unit is arranged to extract the values continuously as the time waveform is acquired.

According to an embodiment of the invention the system comprises storage means for storing the extracted values and the number of counts electronically in a database. The system may comprise a prediction unit configured to predict the residual life of a component such as a bearing, using the stored data or the extracted values and the number of counts.

According to another embodiment of the invention the condition monitoring system is arranged to monitor at least one bearing, such as a rolling element bearing.

It should be noted that the method, computer program and system according to the present invention may be used to monitor at least one component, such as a bearing during the component's manufacture, after the component's manufacture and before the component's use, during the component's use, during a period when the component is not in use and/or during the transportation of the component. A complete history log of a component may thereby be created. Accordingly, as a result of having condition status and/or residual life data accumulated over the component's life, starting with its very manufacturing all the way up to the present, a more accurate prediction can be made regarding the residual life of an individual component at any point in its life-cycle. An analyst or end user may be notified of relevant facts including the time at which it is advisable to replace or refurbish the component.

The method, system and computer program product according to the present invention may be used to monitor at least one component, such as a bearing, used in automotive, aerospace, railroad, mining, wind, marine, metal producing and other machine applications which require high wear resistance and/or increased fatigue and tensile strength.

### BRIEF DESCRIPTION OF THE DRAWINGS

The present invention will hereinafter be further explained by means of non-limiting examples with reference to the appended figures where;

FIG. 1 shows a system according to an embodiment of the invention;

FIG. 2 is a flow chart showing the steps of a method according to an embodiment of the invention; and

FIG. 3 shows examples of time waveforms from which values may be extracted.

It should be noted that the drawings have not been drawn to scale and that the dimensions of certain features have been exaggerated for the sake of clarity.

Furthermore, any feature of one embodiment of the invention can be combined with any other feature of any other embodiment of the invention as long as there is no conflict.

### DETAILED DESCRIPTION OF EMBODIMENTS

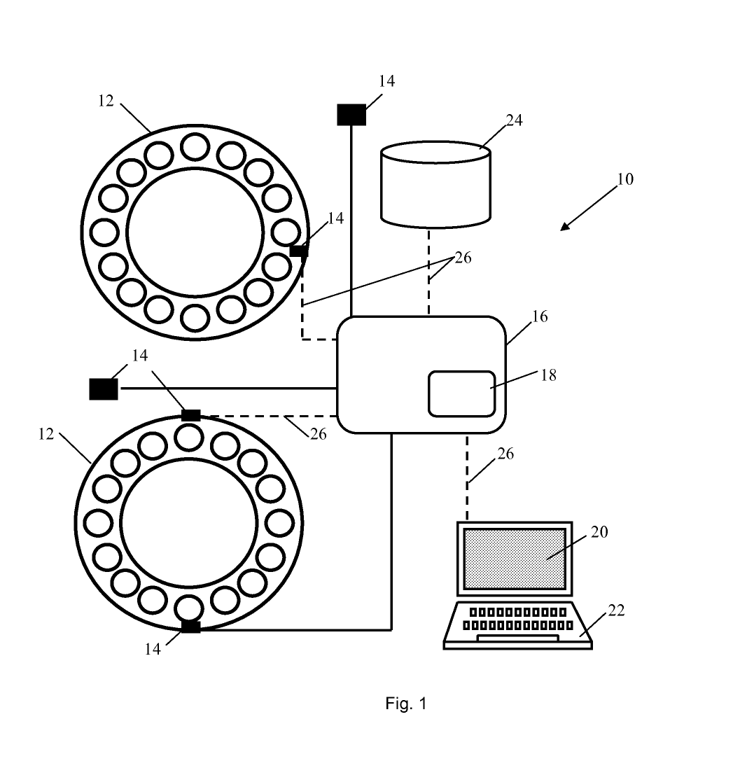

FIG. 1 shows a system 10 for monitoring the condition, and optionally predicting the residual life of a plurality of bearings 12 during their use. The illustrated embodiment shows two rolling element bearings 12, the system 10 according to the present invention may however be used to monitor the condition of one or more components of any type, and not necessarily all of the same type or size. The system 10 comprises a plurality of sensors 14 configured to provide an AE time waveform for the assessment of the bearings 12. A sensor 14, such as an AE sensor, may be integrated with a bearing 12, placed in the vicinity of the bearing 12 or located remotely from the bearing. The sensors 14 may be configured to obtain data periodically, substantially continuously, randomly, on request, or at any suitable time.

The inner ring and/or outer ring of a bearing 12, which can be monitored using a system or method according to an embodiment of the invention, may be of any size and have any load-carrying capacity. An inner ring and/or an outer ring may for example have a diameter up to a few metres and a load-carrying capacity up to many thousands of tonnes.

The system 10 in the illustrated embodiment comprises a processing unit 16 arranged to extract a maximum or minimum or mean value of the time waveform and counts of crossing predetermined threshold values. The system 10 also comprises transmission means 18 arranged to transmit the extracted values and the number of counts to a display means 20 and/or a device 22 used by a user or analyst and/or a database 24 where the extracted values and the number of counts may be electronically recorded. Data may be transmitted to and from the sensors 14, and to and from the processing means 16 in a wired or wireless (26) manner over a wireless communication network.

The database 20 may be maintained by the manufacturer of the bearings 12. The residual life data gathered in the database 20 for a whole batch of bearings 12 enables the manufacturer to extract further information, e.g., about relationships between types or environments of usage versus rates of change of residual life, so as to further improve the service to the end-user.

The system 10 may also comprise a prediction unit (not shown) configured to predict the residual life of each bearing 12 using the recorded data in the database 24 and a mathematical residual life predication model.

It should be noted that not all of the components of the system 10 necessarily need to be located in the vicinity of the bearings 12. For example, the database 24 and/or user device 22 may located at a remote location and communicate with at least one data processing unit 16 located in the same or a different place to the bearings 12 by means of a server for example.

It should also be noted that the at least one data processing unit 16, the transmission means 18 and/or the database 24 need not necessarily be separate units but may be combined in any suitable manner. For example a personal computer may be used to carry out a method concerning the present invention.

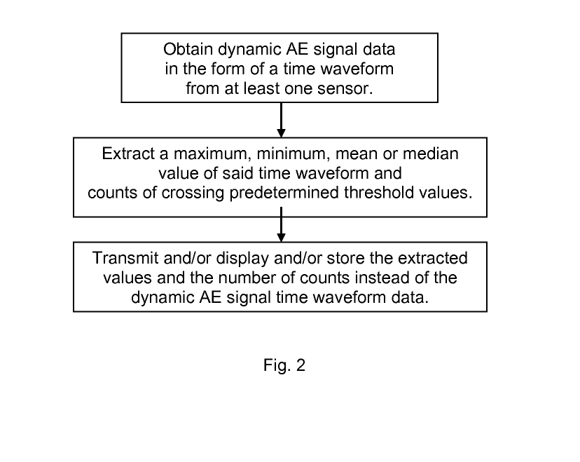

FIG. 2 is a flow chart showing the steps of a method according to an embodiment of the invention. In the method dynamic Acoustic Emission (AE) signal data in the form of a time waveform from at least one sensor: A maximum or minimum or mean value of the time waveform and counts of crossing predetermined threshold values are extracted from the time waveform, and the extracted values and the number of counts are transmitted or displayed or stored instead of said dynamic signal time waveform data. An analyst can decide whether it is necessary to filter the signal.

The extracted values and the number of counts may be transmitted wirelessly over a wireless network, in a wired manner, or in a combination of wired and wireless manners. The extracted values and the number of counts may then be analysed or processed further to obtain condition status information concerning the at least one component being monitored and/or to understand the nature of the original time waveform and any defect(s) associated with it and the severity thereof.

The extracted values and the number of counts may be used to make a prediction of the residual life of a bearing 12. Once such a prediction has been made, it may be displayed on display means 20, and/or sent to a user device 22, bearing manufacturer, database 20 and/or another prediction unit. Notification of when it is advisable to service, replace or refurbish one or more bearings 12 being monitored by the system 10 may be made in any suitable manner, such as via a communication network, via an e-mail or telephone call, a letter, facsimile, alarm signal, or a visiting representative of the manufacturer.

The prediction of the residual life of a bearing 12 may be used to inform a user of when he/she should replace the bearing 12. Intervention to replace the bearing 12 is justified, when the cost of intervention (including labour, material and loss of, for example, plant output) is justified by the reduction in the risk cost implicit in continued operation. The risk cost may be calculated as the product of the probability of failure in service on the one hand, and the financial penalty arising from such failure in service, on the other hand.

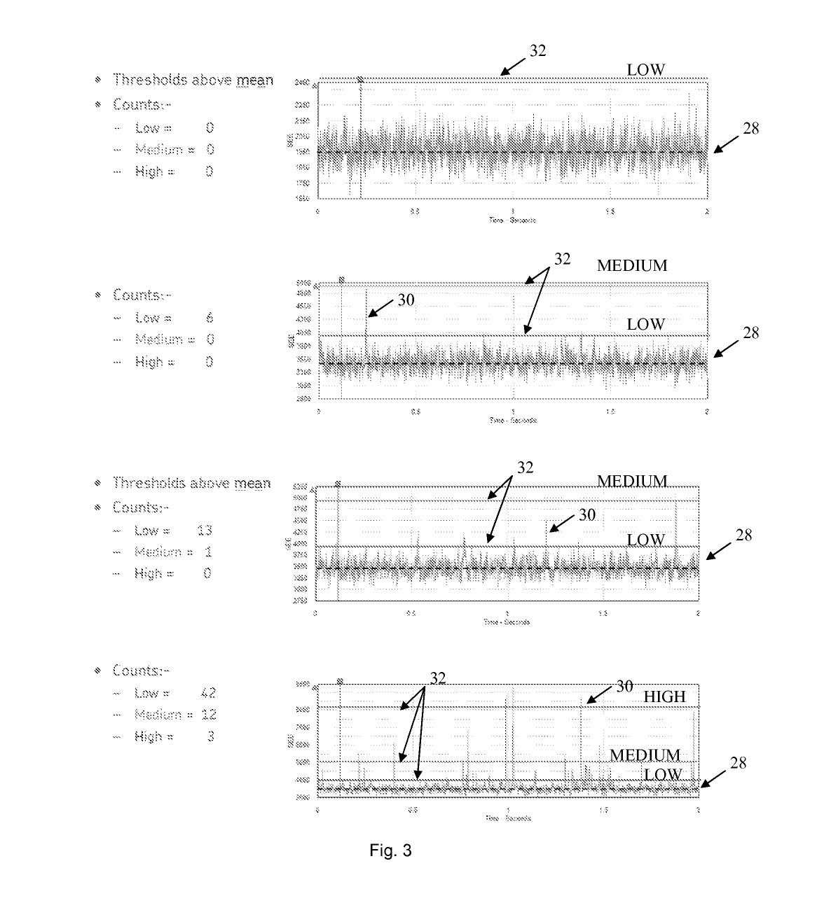

FIG. 3 shows examples of time waveforms from which a maximum or minimum or mean value and counts of crossing predetermined threshold values may be extracted. Counts 30 of transient events crossing predetermined low, medium and high thresholds 32 within time waveforms 28 obtained from a sensor 14 of a condition monitoring system according to the present invention. Analysis of time waveforms 28 to may be performed using standard condition monitoring tools.

Further modifications of the invention within the scope of the claims would be apparent to a skilled person. Even though the described embodiments are directed to a method, system and computer program product for monitoring at least one component such as a bearing, such a method, system and computer program product may be used for monitoring and optionally predicting the residual life of another component of rotating machinery, such as a gear wheel.

1. A method for processing data obtained from a condition monitoring system, the method comprising steps of:
obtaining dynamic Acoustic Emission signal data in the form of a time waveform from at least one sensor;
extracting one of a maximum value, a minimum value, or a mean value of the time waveform and values of crossing predetermined threshold values; and
one of transmitting, displaying, or storing the extracted values and the number of counts instead of the dynamic signal time waveform data.

2. The method according to claim 1, wherein the counts of crossing predetermined threshold values are any of the following:
periodic events, or
amplitudes.

3. The method according to claim 1, the extracted values and the number of counts are transmitted wirelessly over a wireless communication network.

4. The method according to claim 1, it is carried out once the whole of the time waveform has been acquired.

5. The method according to claim 1, it is carried out continuously as the time waveform is acquired.

6. The method according to claim 1, it comprises the step of storing the extracted values and the number of counts electronically in a database.

7. The method according to claim 1, the condition monitoring system is arranged to monitor at least one bearing, such as a rolling element bearing.

8. A computer program product, comprising:
a computer program containing computer program code arranged to cause one of a computer or a processor to execute steps of:
obtaining dynamic Acoustic Emission signal data in the form of a time waveform from at least one sensor;
extracting one of a maximum value, a minimum value, or a mean value of the time waveform and values of crossing predetermined threshold values; and
one of transmitting, displaying, or storing the extracted values and the number of counts instead of the dynamic signal time waveform data,
wherein the computer program is stored on a computer-readable medium or a carrier wave.

9. A system for processing data obtained from a condition monitoring system including at least one sensor arranged to provide dynamic Acoustic Emission signal data in a form of a time waveform from the at least one sensor, the data processing system comprising:
a processing unit arranged to extract one of a maximum value, a minimum value, or a mean value of the time waveform and counts of crossing predetermined threshold values, and a transmission feature arranged to one of transmit, display, or store the extracted values and the number of counts instead of the dynamic signal time waveform data.

10. The system according to claim 9, wherein the counts of crossing predetermined threshold values are any of the following:
periodic events, or
amplitudes.

11. The system according to claim 9, further comprising a transmitting feature arranged to transmit the extracted values and the number of counts wirelessly over a wireless communication network.

12. The system according to claim 9, wherein the processing unit is arranged to extract the values and the counts of crossing predetermined threshold values once the whole of the time waveform has been acquired.

13. The system according to claim 9, the processing unit is arranged to extract the values and the counts of crossing predetermined threshold values continuously as the time waveform is acquired.

14. The system according to claim 9, further comprising a storage component for storing the extracted values and the number of counts electronically in a database.

15. The system according to claim 9, wherein the condition monitoring system is arranged to monitor at least one bearing.

16. The system according to claim 9, wherein the condition monitoring system is arranged to monitor at least one rolling element bearing.

17. The method according to claim 1, wherein the condition monitoring system is arranged to monitor at least one rolling element bearing.
